(19) United States
(12) Patent Application Publication
(10) Pub. No.: US 2026/0258800 A1
(43) Pub. Date: Sep. 3, 2026

(54) OIL OVERFLOW CONTROL FOR DIAPHRAGM COMPRESSOR

(71) Applicant: Howden Thomassen Compressors B.V., Rheden (NL)

(72) Inventors: Rens Pieter Arnoldus Hulstijn, Zelhem (NL); Petrus Antonius Gerardus Polman, Apeldoorn (NL); Sun Xiaohong, Weihai (CN); Liang Xiangyang, Weihai (CN); Mu Zongjin, Weihai (CN); Sun Yuping, Beijing (CN)

(21) Appl. No.: 19/656,382

(22) Filed: Apr. 23, 2026

Related U.S. Application Data
(63) Continuation of application No. PCT/CN2023/126803, filed on Oct. 26, 2023.

(51) Int. Cl. F04B 45/053; F04B 53/12

(52) U.S. Cl. CPC F04B 45/0536; F04B 53/125; F04B 2205/03

(57) ABSTRACT

An oil overflow assembly is disclosed. The oil overflow assembly includes a valve subassembly and a control subassembly. The valve subassembly is configured to be operably coupled to an oil side of a diaphragm head of a diaphragm compressor and includes a valve cone configured to selectively seal a valve seat. The control subassembly includes a diaphragm and a diaphragm spring. The diaphragm is operably coupled to the valve cone and configured to move the valve cone into and out of engagement with the valve seat. The diaphragm spring engages with the diaphragm and biases the diaphragm into a sealed position where the diaphragm maintains the valve cone in engagement with the valve seat.

### FIELD OF INVENTION

The present invention relates to the field of diaphragm compressors and, in particular, to techniques for controlling and regulating oil pressure with respect to working fluid pressure in a diaphragm compressor.

### BACKGROUND

Diaphragm compressors include a diaphragm capable of generating pressure differentials (e.g., by flexing and/or oscillating) that are sufficient to create an intake stroke and an output stroke to act on a working fluid. The diaphragm in a diaphragm compressor also separates an oil side from a gas or working fluid side (e.g., a gas side). Then, pressure changes in the oil and/or the working fluid can move the diaphragm through its intake and/or the output stroke. For example, a piston can oscillate on the oil side to change the pressure of the oil and cause the diaphragm to compress and exhaust working fluid.

Over time, oil can leak from the oil side and, thus, many diaphragm compressors include an oil compensation circuit to compensate for oil leakage. In at least some instances, a pump in this oil compensation circuit is driven by piston movement, thereby tying oil compensation to piston movement. Regardless, the amount of oil pumped by this pump is often larger than necessary, primarily because pumping a quantity of oil less than the leaked quantity can lead to catastrophic failure. However, at the same time, overfilling the oil side can create an unwanted increase in oil pressure. To prevent this, the oil side often includes an oil overflow assembly, which limits the oil pressure on the oil side (e.g., to lower the oil pressure at the forward dead point of the piston to a value which is slightly above the maximum pressure of a working fluid). Due to the conflicting nature of the oil overflow assembly and the compensation circuit, controlling the relationship between these components is very important.

In fact, often, a diaphragm compressor can only function reliably if the relationship between the working gas pressure and the oil pressure is carefully and constantly controlled, without allowing variations outside of a specific range. Thus, the relationship between the oil overflow assembly and the compensation circuit is often the most important relationship in a diaphragm compressor (e.g., since this relationship controls the oil pressure which, in turn, controls the ratio of oil pressure to working fluid pressure).

To address this, some diaphragm compressors utilize an overflow assembly formed from only a spring-biased valve (e.g., check valves). Then, improving on this, other diaphragm compressors have incorporated electronically controlled pistons into overflow assemblies to try to pretension an overflow valve and allow for more nuanced control. One example of such an overflow valve can be found in U.S. Patent No. 6,767,189. However, further improvements are continually desired, at least because of the critical importance of constantly maintaining the relationship between the working gas pressure and the oil pressure without allowing variations outside of a specific range.

### SUMMARY

Techniques for controlling oil pressure in a diaphragm compressor are disclosed. These techniques may be embodied as one or more methods, one or more apparatuses (e.g., oil overflow assemblies), and/or one or more systems (e.g., diaphragm compressors).

In accordance with at least one embodiment, the present application is directed to an oil overflow assembly that includes a valve subassembly and a control subassembly. The valve subassembly is configured to be operably coupled to an oil side of a diaphragm head of a diaphragm compressor and includes a valve cone configured to selectively seal a valve seat. The control subassembly includes a diaphragm and a diaphragm spring. The diaphragm is operably coupled to the valve cone and configured to move the valve cone into and out of engagement with the valve seat. The diaphragm spring engages with the diaphragm and biases the diaphragm into a sealed position where the diaphragm maintains the valve cone in engagement with the valve seat.

Among other advantages, utilizing a diaphragm spring allows the diaphragm to be quickly and accurately actuated, at least as compared to a piston or diaphragm that is not coupled to such a spring. That is, the diaphragm spring improves the response time of the oil overflow assembly at least as compared to oil overflow solutions that do not include such a spring. In turn, this improved response time allows for careful management of the ratio of oil pressure to working gas/fluid pressure and, thus, can extend the lifetime of a diaphragm compressor to which the oil overflow assembly is connected. Moreover, the diaphragm spring provides a safety enhancement since it will bias the diaphragm to its sealed position even if pressure is not maintained in the diaphragm chambers.

In some of these embodiments, the oil overflow assembly also includes a transition subassembly including a piston configured to transfer actuations of the diaphragm to the valve cone. In at least some of these instances, the piston may be mechanically coupled to a downstream surface of the diaphragm. Additionally or alternatively, the piston includes one or more radial seals configured to prevent oil from coming into contact with the diaphragm. Thus, the piston may help ensure that the diaphragm is not exposed to contaminating oil. Still further, in some instances, the valve subassembly includes a spring configured to extend between the piston and the valve cone. The spring may help transfer forces from the diaphragm to the valve cone.

In some embodiments, the control subassembly also includes a setting screw configured to adjust a preload on the diaphragm spring. Thus, an initial and/or fail-safe oil pressure can be set and adjusted for different applications, either manually or automatically. Additionally or alternatively, the diaphragm is a flexible diaphragm. In fact, in some instances, the diaphragm can provide pneumatic control of the valve cone. For example, in some embodiments, working fluid (e.g., working gas) can be routed into chambers disposed upstream and downstream of the diaphragm to provide pneumatic control of the valve cone.

In accordance with another embodiment, the present application is directed to a diaphragm compressor including a cylinder and an oil overflow assembly. The cylinder is in fluid communication with a compressor diaphragm so that the cylinder and a first side of the compressor diaphragm define an oil side while a second side of the compressor diaphragm defines a gas side. The oil overflow assembly is configured to maintain a ratio between a maximum oil pressure on the oil side and a maximum gas pressure on the gas side and may include any combination of the features mentioned above (among others). Thus, the oil overflow assembly (and the diaphragm compressor) may realize the foregoing advantages, as well as other advantages described herein.

In some instances, the diaphragm compressor includes an I/P converter configured to generate signals based on pressures of at least the gas side. The signals cause a pneumatic actuation of the diaphragm to maintain the ratio between the maximum oil pressure on the oil side and the maximum gas pressure on the gas side. This provides careful and accurate control of the valve subassembly which, in turn, carefully controls the ratio of maximum oil pressure to maximum gas pressure.

These and other advantages and features will become evident in view of the drawings and detailed description.

### BRIEF DESCRIPTION OF THE DRAWINGS

To complete the description and in order to provide for a better understanding of the present invention, a set of drawings is provided. The drawings form an integral part of the description and illustrate an embodiment of the present invention, which should not be interpreted as restricting the scope of the invention, but just as an example of how the invention can be carried out. The drawings comprise the following figures:

FIG. 1 illustrates a side, sectional view of a prior art diaphragm head that is suitable for a diaphragm compressor.

FIG. 2 is an enlarged view of a prior art oil overflow assembly that may be included in the prior art diaphragm head of FIG. 1.

FIG. 3 is a perspective view of an oil overflow assembly according to an embodiment of the present application.

FIG. 4 is a side sectional view of the oil overflow assembly of FIG. 3.

FIG. 5 is a block diagram illustrating a control loop within which the oil overflow assembly presented herein may be incorporated.

Like reference numerals have been used to identify like elements throughout this disclosure.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

Generally, the present application is drawn to techniques for controlling and regulating oil pressure with respect to working fluid pressure in a diaphragm compressor. These techniques may be embodied as an oil overflow assembly that, among other features, includes a control subassembly with a diaphragm and a diaphragm spring. The diaphragm can provide control of a valve in the oil overflow assembly, e.g., pneumatically or hydraulically, and, among other advantages, the diaphragm spring improves the response time of the oil overflow assembly, at least as compared to oil overflow solutions that do not include such a spring. In turn, this improved response time allows for careful management of the ratio of oil pressure to working gas/fluid pressure and, thus, can extend the lifetime of a diaphragm compressor to which the oil overflow assembly is connected.

Moreover, the diaphragm spring provides a safety enhancement since it will bias the diaphragm to its sealed position even if pressure is not maintained in the diaphragm chambers. This may be particularly important if the control techniques presented herein are implemented in hazardous environments, such as atmospheres explosibles (“ATEX”) environments.

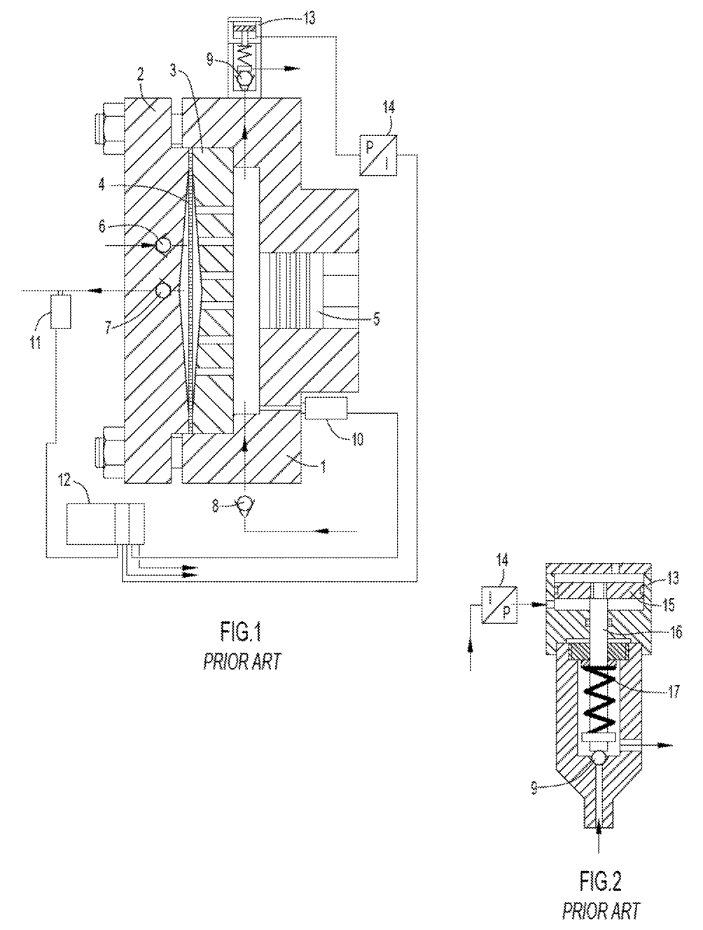

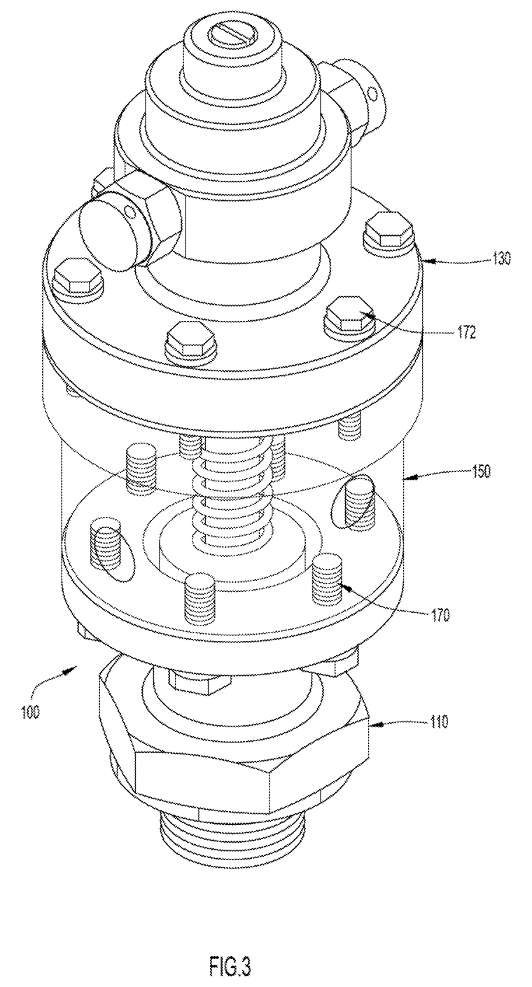

Now referring to FIGS. 1 and 2, these Figures depict a prior art embodiment of an oil overflow assembly, with FIG. 1 depicting the assembly at a high-level while included in a diaphragm head that is suitable for a diaphragm compressor and FIG. 2 depicting the assembly in further detail. As shown in FIG. 1, an oil overflow assembly sits above a cylinder 1 that is closed by a cover 2. In the prior art embodiments, the cover 2 works with an aperture plate 3 to sandwich a diaphragm 4 of the diaphragm compressor, creating an oil side inside the cylinder 1 and a gas side that is accessible via valves 6 and 7. On the oil side, the pressure of the oil can be manipulated by a piston 5, the displacement volume (surface area multiplied by stroke length) of which can be tuned based on the displacement volume of the diaphragm 4 (e.g., so that the piston displacement volume is smaller than the diaphragm displacement volume).

Additionally, oil can be supplied into the cylinder 1 to compensate for leakage (e.g., around piston 5) via valve 8, for example, by pumping oil through valve 8 with an eccentric pump that is synchronized with movement of piston 5. As mentioned, for the diaphragm pump to remain operational, the amount of oil pumped through valve 8 must always be at least as much as the leakage. Thus, the amount of oil entering the cylinder 1 via valve 8 is often greater than necessary and, the overflow assembly above the cylinder 1 includes an oil overflow valve 9 to allow excess oil to exit the cylinder 1 (e.g., when the piston 5 is at its forward dead point). The valve 9 then controls the maximum oil pressure in the cylinder 1, for example to be approximately 10% greater than the maximum gas pressure on the gas side.

In the depicted prior art embodiment, the overflow valve 9 is incorporated into an oil overflow assembly that includes a relief mechanism 13 controlled based on signals received from a current-to-pressure transducer 14 (I/P converter 14). The I/P converter 14 is connected to controller 12 that is processing inputs from a pressure sensor 10 on the oil side and a pressure sensor 11 on the gas side. Thus, the controller 12 can compute specific commands to maintain a specific ratio of gas pressure to oil pressure, for example, so that the oil pressure is approximately 10% greater than the maximum gas pressure.

As can be seen best in FIG. 2, in the prior art embodiment, the relief mechanism 13 includes a piston 15 that can be actuated (e.g., by adjusting a pressure in a chamber upstream of piston 15) to exert a force on valve spindle 16. This force then loads or unloads a pretensioned valve spring 17 to open or close valve 9. While somewhat effective, this prior art oil overflow assembly does not always respond quickly because the actuation is entirely based on controlling a pressure in the chamber upstream of piston 15 after processing multiple pressure signals. Thus, the prior art oil overflow assembly can sometimes provide inaccurate control of the overflow valve 9 that leads to imprecise control of the critical ratio of the gas pressure to oil pressure.

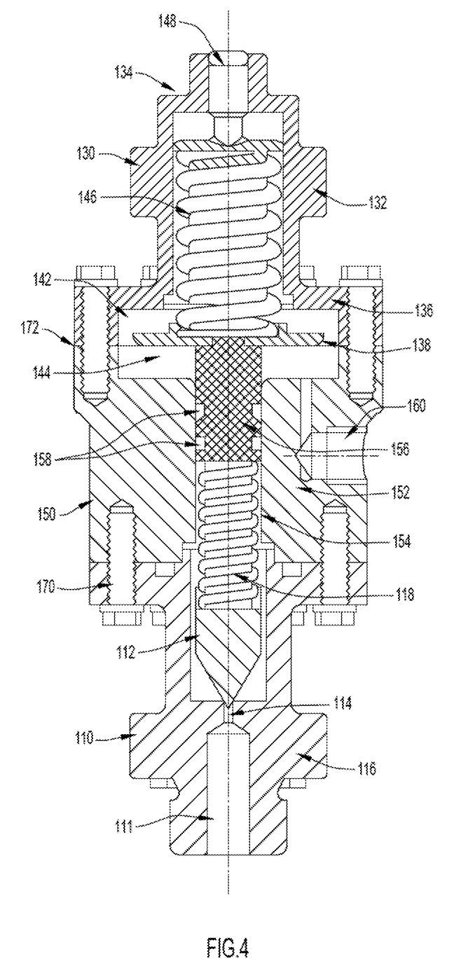

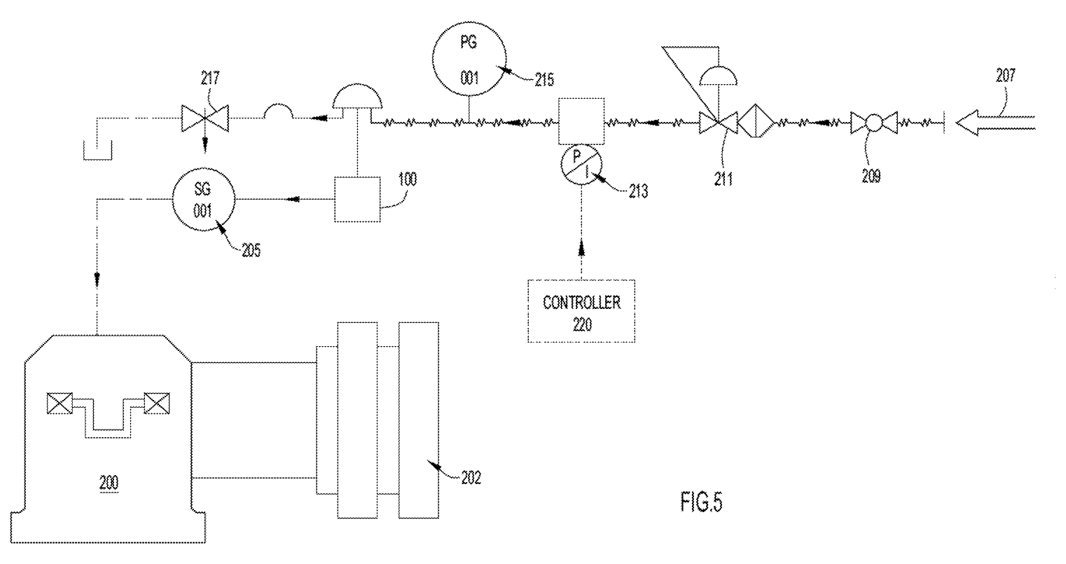

Now turning to FIGS. 3 and 4, for a description of an exemplary embodiment of the oil overflow assembly presented herein. In these Figures, the oil overflow assembly 100 (also referred to as auto-limiter 100) is formed from three parts or subassemblies: a valve subassembly 110, a control subassembly 130, and a transition subassembly 150. The transition subassembly 150 is generally positioned between the valve subassembly 110 and the control subassembly 130 and is configured to operably couple the valve subassembly 110 to the control subassembly 130.

More specifically, in the depicted embodiment, each of subassemblies 110, 130, and 150 is manufactured separately and bolted together, with bolts 170 connecting the control subassembly 130 and the transition subassembly 150, and bolts 172 connecting the transition subassembly 150 and the valve subassembly 110. However, in other embodiments, one or more of subassemblies 110, 130, and 150 can be formed together and/or connected together in any other manner. Moreover, in the depicted embodiment, each of subassemblies 110, 130, and 150 is generally cylindrical (aside from the hexagonal installation flange on the valve subassembly 110); but, in other embodiments the oil overflow assembly 100 may have any shape(s) or size(s).

As can be seen in FIG. 4, the valve subassembly 110 includes a main body 116 that defines an oil conduit 111 that extends from a distal end of the main body 116 to a valve seat 114, which is narrower than the oil conduit 111. The valve subassembly 110 also includes a valve cone 112 that is configured to selectively seal the valve seat 114. More specifically, a proximal end of the valve cone 112 is tapered towards the valve seat 114 so that at least a portion of the valve cone 112 can fit into and seal the valve seat 114. Meanwhile, a distal end of the valve cone 112 is coupled to a spring 118 that is configured to control movement of the valve cone 112. The spring 118 may also bias the valve cone 112 into a position that seals the valve seat 114, depending on positions of elements of the control subassembly 130 and the transition subassembly 150 (as explained in further detail below).

At the other end of the oil overflow assembly 100, the control subassembly 130 includes a main body 132 that extends from a top end 134 to a bottom end 136. The top end 134 is generally narrower than the bottom end 136 so that the main body 132 can define a conduit for a diaphragm spring 146 while the bottom end 136 can define, at least in part, a chamber for a control diaphragm 138. Critically, the diaphragm spring 146 engages a top surface of the control diaphragm 138 to enable quick and controlled actuation of the control diaphragm 138.

Moreover, the diaphragm spring 146 biases the control diaphragm 138 to a downward or distal position (also referred to as a sealed position) where the diaphragm 138 compresses the valve spring 118 (via a piston 156, which is described below) and maintains the valve cone 112 in the valve seat 114, sealing the valve seat 114. Thus, overall, if air pressure is lost in control subassembly 130, the diaphragm spring 146 provides a fail-safe mechanism that allows the valve subassembly 110 to continue operating. This also ensures that oil remains segregated from gas, even in the event of a failure. As mentioned, this may be particularly important if the control techniques presented herein are implemented in hazardous environments, such as ATEX environments. However, in such environments, the oil overflow assembly 100, a controller connected thereto, or portions thereof may also be positioned in an enclosure to provide additional safety protections.

Regardless of the environment in which the oil overflow assembly 100 is used, the diaphragm spring 146 may be operatively coupled, at its top or distal end, to a setting screw 148 that can preload the diaphragm spring 146 to a variety of preload settings. For example, the setting screw 148 may be manually adjustable so that a user can set the diaphragm spring 146 to a setting associated with an expected or initial maximum gas pressure setting (e.g., a maximum pressure of gas flowing through the gas side of a diaphragm compressor on which the oil overflow assembly 100 is included). Alternatively, the setting screw 148 might be adjusted automatically. Either way, if air pressure is lost in control subassembly 130, the diaphragm spring 146 will not simply close the valve seat 114 but will revert the diaphragm spring 146 to a setting associated with an expected or initial maximum gas pressure setting, which will allow the valve cone 112 to continue to selectively open the valve seat 114 to maintain operations of a diaphragm compressor on which the oil overflow assembly 100 is included.

In the depicted embodiment, the main body 132 of the control subassembly 130 cooperates with the transition subassembly 150 to define a cylinder for the control diaphragm 138. In particular, an upstream chamber 142 of the cylinder is defined in the main body 132 while a downstream chamber 144 is defined in a main body 152 of the transition subassembly 150. Additionally, the transition subassembly 150 includes a piston 156 that is movably positioned within a conduit 154 (defined by main body 152) that extends from the downstream chamber 144 to the valve subassembly 110. However, in other embodiments, the control subassembly 130 or the transition subassembly 150 may define both chambers or any portions thereof.

In any case, the piston 156 is not entirely free to move within conduit 154. Instead, the piston 156 is coupled to a downstream surface/face of the control diaphragm 138. Thus, piston 156 moves with the control diaphragm 138 to transfer actuations of the control diaphragm 138 to the valve cone 112 and create variable oil pressure settings for the oil overflow assembly 100. In turn, these variable pressure settings vary the pressure of the oil side precisely based on gas side pressures. In at least some embodiments, the piston 156 transfers actuations of the control diaphragm 138 to the valve cone 112 pneumatically; however, in alternative embodiments, the piston 156 may transfer actuations of the control diaphragm 138 to the valve cone 112 hydraulically or in any other similar manner now known or developed hereafter.

While the size of the downstream chamber 144 may be carefully designed to constrain the control diaphragm 138 and the piston 156, the upstream chamber 142 may allow more freedom to allow “breathing” of the control diaphragm 138. That is, breathing is carefully considered in designing the upstream chamber 142 to allow free movement of diaphragm 138, the diaphragm spring 146, and the setting screw 148.

Aside from the downstream chamber 144, the transition subassembly 150 also defines a drain 160 connected to the downstream chamber 144. This drain is mostly precautionary, however, since oil is not intended to enter the downstream chamber 144. This is because seals 158 (e.g., two O-rings or other such elements) extend radially around the piston 156 to prevent oil from entering the downstream chamber 144. Moreover, since the downstream chamber 144 will be pressurized during diaphragm operations, (e.g., with pressurized air at pressures of 1.0-4.0 barg), it might be nearly impossible for oil to enter the downstream chamber 144. Nevertheless, should both of seals 158 fail and a flow of oil is able to overcome the air pressure in the diaphragm chamber, the drain 160 provides a fail-safe.

Importantly, the control diaphragm 138 is flexible (i.e., non-metallic) and, thus, can provide pneumatic and/or hydraulic actuating control of the valve cone 112. For example, in at least some embodiments, the control subassembly 130 can be connected to an I/P converter that is connected to pressure sensors on at least the gas side of a diaphragm compressor on which the oil overflow assembly 100 is included. Then, the I/P converter can convert air pressures (e.g., of 1.0-4.0 barg) into signals that work the control diaphragm 138 in a reversed action against the diaphragm spring 146 to create pneumatic/hydraulic actuations associated with variable pressure settings for the oil overflow assembly 100 that vary the pressure of the oil side precisely based on gas side pressures. Other components capable of converting sensed parameters into signals, such as controllers, microprocessors, and the like, might also be used instead of or in combination with the I/P converter. In any case, at least because the oil overflow assembly 100 includes the diaphragm spring 146 acting on the control diaphragm 138, the control diaphragm 138 will rapidly return to its resting or biased position (i.e., its sealed position) subsequent to an actuation that compresses the diaphragm spring 146. This provides rapid closures and extremely accurate control.

Alternatively, the flexible control diaphragm 138 might be controlled without any software. For example, actuation fluid (e.g., hydraulic or pneumatic fluid) for the control diaphragm 138 might be controlled with mechanical linkages that tie the actuating control of the valve cone to pressure variations on the oil side. In any case, these pneumatic/hydraulic actuations generated by the control diaphragm 138 are transmitted to the valve cone 112 via the spring 118 to limit the pressure difference between the maximum oil pressure (e.g., in the cylinder of a diaphragm compressor) and gas pressure exiting/downstream of the compressor. Additionally or alternatively, the pneumatic/hydraulic actuations may ensure that the diaphragm compressor operates with a minimum pressure ratio of maximum oil pressure to gas pressure exiting/downstream of the compressor. In turn, these adjustments may ensure that oil pressure in the diaphragm head does not increase the head design pressure, which will extend the lifespan of the diaphragm compressor on which the oil overflow assembly is installed.

Now turning to FIG. 5, this Figure depicts an example control loop for the oil overflow assembly 100 presented herein. As can be seen, the oil overflow assembly 100 is generally controlled by an I/P Converter 213. In some embodiments, the oil overflow assembly 100 may be operated in a manual pressure setting mode, which can be set locally or remotely, such as via a controller 220 (e.g., a programmable logic controller (PLC) and/or distributed control system (DCS)).

Additionally, or alternatively, the oil overflow assembly 100 may operate automatically, e.g., with the I/P Converter 213 converting pressure data from the gas side of the diaphragm head 202 of compressor 200 into signals that control the oil overflow assembly 100. For example, the signals may control a flow of actuating fluid (e.g., pneumatic or hydraulic fluid) that flows to the oil overflow assembly 100 from a fluid supply 207 (e.g., pneumatic fluid) by controlling a valve 209 and/or pressure regulator 211 disposed between the fluid supply 207 and the oil overflow assembly 100. In at least some embodiments, pressure data is obtained through pressure sensors in direct contact with the gas (not shown); however, in other embodiments, such data might be gathered via sight glass 205. In any case, the control signals may also be further based on a sensed pressure or the actuating fluid directed toward the oil overflow assembly 100, e.g., as sensed by pressure gauge 215 (e.g., to create a feedback loop). The pressure might also be adjustable via venting through drain valve 217, which may, in some embodiments, be connected to drain 160 (see FIG. 4).

While this application has described the techniques presented herein in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Finally, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Similarly, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”. Finally, for the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

1. An oil overflow assembly comprising:
a valve subassembly configured to be operably coupled to an oil side of a diaphragm head of a diaphragm compressor, the valve subassembly including a valve cone configured to selectively seal a valve seat; and
a control subassembly including:
a diaphragm that is operably coupled to the valve cone and configured to move the valve cone into and out of engagement with the valve seat; and
a diaphragm spring engaged with the diaphragm and biasing the diaphragm into a sealed position where the diaphragm maintains the valve cone in engagement with the valve seat.

2. The oil overflow assembly of claim 1, further comprising:
a transition subassembly including a piston configured to transfer actuations of the diaphragm to the valve cone.

3. The oil overflow assembly of claim 2, wherein the piston is mechanically coupled to a downstream surface of the diaphragm.

4. The oil overflow assembly of claim 2, wherein the piston includes one or more radial seals configured to prevent oil from contacting the diaphragm.

5. The oil overflow assembly of claim 2, wherein the valve subassembly includes a spring configured to extend between the piston and the valve cone.

6. The oil overflow assembly of claim 1, wherein the control subassembly further comprises:
a setting screw configured to adjust a preload on the diaphragm spring.

7. The oil overflow assembly of claim 1, wherein the diaphragm provides pneumatic control of the valve cone.

8. The oil overflow assembly of claim 1, wherein the diaphragm is a flexible diaphragm.

9. A diaphragm compressor comprising:
a cylinder in fluid communication with a compressor diaphragm, the cylinder and a first side of the compressor diaphragm defining an oil side and a second side of the compressor diaphragm defining a gas side; and
an oil overflow assembly configured to maintain a ratio between a maximum oil pressure on the oil side and a maximum gas pressure on the gas side, the oil overflow assembly comprising:
a valve subassembly operably coupled to the oil side, the valve subassembly including a valve cone configured to selectively seal a valve seat; and
a control subassembly including:
a diaphragm that is operably coupled to the valve cone and configured to move the valve cone into and out of engagement with the valve seat; and
a diaphragm spring engaged with the diaphragm and biasing the diaphragm into a sealed position where the diaphragm maintains the valve cone in engagement with the valve seat.

10. The diaphragm compressor of claim 9, further comprising:
an I/P converter configured to generate signals based on pressures of at least the gas side, the signals causing a pneumatic actuation of the diaphragm to maintain the ratio between the maximum oil pressure on the oil side and the maximum gas pressure on the gas side.

11. The diaphragm compressor of claim 9, wherein the control subassembly further comprises:
a setting screw configured to adjust a preload on the diaphragm spring.

12. The diaphragm compressor of claim 9, wherein the oil overflow assembly further comprises:
a transition subassembly including a piston configured to transfer actuations of the diaphragm to the valve cone.

13. The diaphragm compressor of claim 12, wherein the piston is mechanically coupled to a downstream surface of the diaphragm.

14. The diaphragm compressor of claim 9, wherein the diaphragm provides pneumatic control of the valve cone.

15. The diaphragm compressor of claim 9, wherein the diaphragm is a flexible diaphragm.

16. A method of maintaining a ratio between a maximum oil pressure on an oil side of a compressor diaphragm and a maximum gas pressure on a gas side of the compressor diaphragm with an oil overflow assembly, the method comprising:
moving a valve cone of a valve subassembly on the oil side out of engagement with a valve seat via a diaphragm to maintain the ratio between the maximum oil pressure and the maximum gas pressure; and
subsequent to moving the valve cone out of engagement with the valve seat, returning the valve cone to engagement with the valve seat with a diaphragm spring that is engaged with the diaphragm.

17. The method of claim 16, further comprising:
generating signals based on pressures of at least the gas side; and
actuating the diaphragm based on the signals to maintain the ratio between the maximum oil pressure and the maximum gas pressure.

18. The method of claim 16, further comprising:
adjusting a preload on the diaphragm spring via a setting screw.

19. The method of claim 16, wherein the diaphragm moves the valve cone via pneumatic control.

20. The method of claim 16, wherein the diaphragm is a flexible diaphragm.
